(19) United States
(12) Patent Application Publication
(10) Pub. No.: US 2021/0101647 A1
(43) Pub. Date: Apr. 8, 2021

(54) ELONGATED STORAGE COMPARTMENTS INTEGRATED INTO A VEHICLE

(71) Applicant: Toyota Motor Engineering & Manufacturing North America, Inc., Plano, TX (US)

(72) Inventors: Don Federico, Manchester, MI (US); Mark D. Benton, Ann Arbor, MI (US)

(21) Appl. No.: 16/595,868

(22) Filed: Oct. 8, 2019

(51) Int. Cl. B62D 33/04; B60R 9/06; B60R 9/02

(52) U.S. Cl. CPC B62D 33/044; B60R 9/02; B60R 9/065

(57) ABSTRACT

A pickup truck includes a cargo bed having a sidewall. The sidewall has a first wall portion facing into the cargo bed a second wall portion residing opposite and spaced apart from the first wall portion in a direction away from the cargo bed. A cavity is formed between the first and second wall portions. An insert is positioned within the cavity. The insert defines at least one elongated compartment extending along the cavity in a direction leading from a rear end of the pickup truck toward a front end of the pickup truck.

### TECHNICAL FIELD

The present invention relates to storage areas provided in a vehicle and, more particularly, to storage compartments incorporated into a vehicle and structured for storing and transporting elongated items.

### BACKGROUND

Users of vehicles, in particular pickup trucks, frequently desire to load, secure, and transport elongated items such as fishing poles and skis. However, it may be difficult to secure such items for transport in a pickup cargo bed. In addition, such items may be easily seen when positioned in an uncovered cargo bed, thereby subjecting the items to possible theft from an unattended vehicle. Unprotected items residing in the cargo bed may also be subject to weather damage. These items also occupy cargo bed space that may otherwise be usable for transporting other items.

### SUMMARY

In one aspect of the embodiments described herein, a vehicle is provided. The vehicle includes a cargo bed having a sidewall. The sidewall has a first wall portion facing into the cargo bed a second wall portion residing opposite and spaced apart from the first wall portion in a direction away from the cargo bed. A cavity is formed between the first and second wall portions. An insert is positioned within the cavity. The insert defines at least one elongated compartment extending along the cavity in a direction leading from a rear end of the vehicle toward a front end of the vehicle.

### BRIEF DESCRIPTION OF THE DRAWINGS

The accompanying drawings, which are incorporated in and constitute a part of this specification, illustrate embodiments described herein and together with the description serve to explain principles of embodiments described herein.

FIG. 1A is a schematic perspective view of a rear portion of a pickup truck incorporating one or more elongated compartments in accordance with an embodiment described herein, and showing a tailgate of the pickup truck in an open condition.

FIG. 1B is the schematic perspective view of FIG. 1A showing the tailgate in a closed condition.

### DETAILED DESCRIPTION

Embodiments described herein relate to elongated storage compartments incorporated into walls of a vehicle. In a particular embodiment, the elongated compartments are incorporated into one or more sidewalls of a pickup truck. The elongated compartments may be provided in molded inserts structured to be positioned inside the sidewalls, between an interiorly-facing (i.e., facing toward the vehicle interior) wall portion of the sidewall and another portion of the sidewall facing toward an exterior of the vehicle and positioned opposite the interiorly-facing wall portion. The elongated compartments may be used to store, transport, and secure relatively long items such as skis and fishing poles. The elongated compartments may be accessible from a rear portion of the sidewall, when the tailgate is open. The elongated compartments may be closed and concealed from view by closing the tailgate. The compartments may also be secured or locked by locking the closed tailgate using the tailgate lock already incorporated into the tailgate.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. Unless otherwise noted, similar reference characters are used to describe similar features on separate elements and/or embodiments.

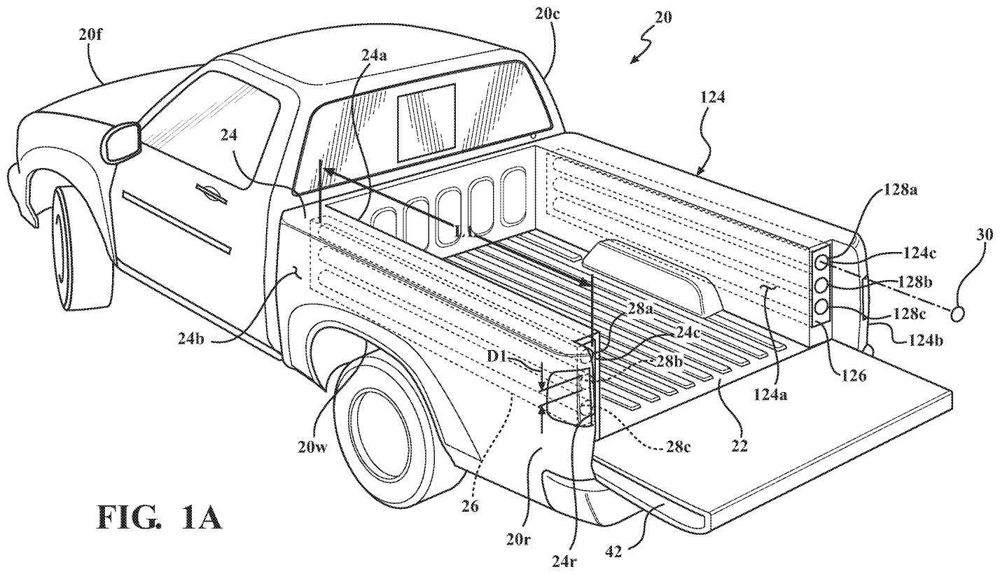

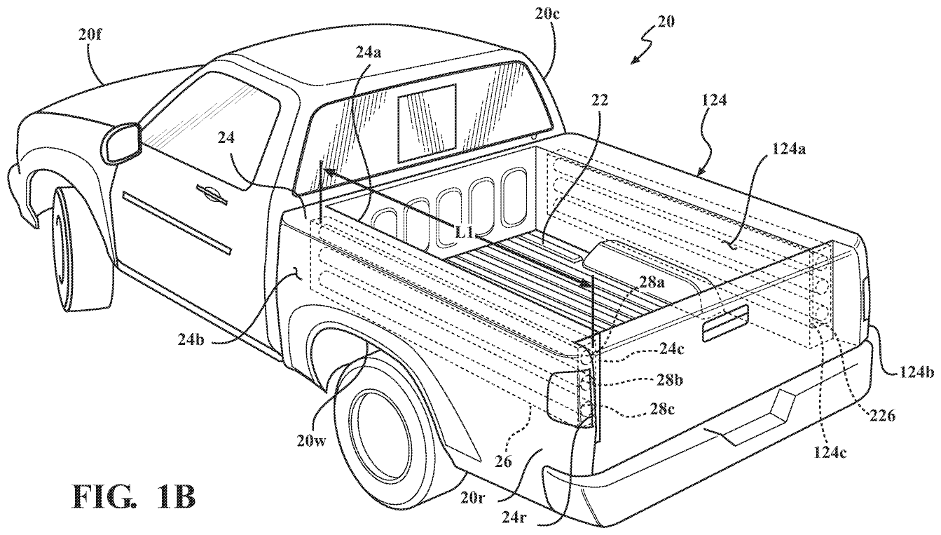

FIG. 1A is a schematic perspective view of a rear portion of a vehicle incorporating one or more elongated compartments in accordance with an embodiment described herein. In the particular embodiment shown in FIGS. 1A and 1B, the vehicle is a pickup truck. Although embodiments of the elongated compartments will be described herein as they may be incorporated into a pickup truck, it will be understood that embodiments of the elongated compartments may be incorporated into any type of vehicle having structural features suitable for incorporating of the elongated compartments therein. For example, elongated compartments as described herein may be incorporated into any vehicle having a wall into which a suitable cavity may be formed, and where access to the elongated compartments may be enabled and prevented by operation of a structure such as a conventional swinging door, a sliding door, or a liftgate.

Referring to FIGS. 1A and 1B, the pickup truck 20 may include a cargo bed 22 having a sidewall 24. The sidewall 24 may have a first wall portion 24a facing into the cargo bed 22. The sidewall 24 may also have a second wall portion 24b residing opposite and spaced apart from the first wall portion 24a, facing in a direction away from the cargo bed 22. In one or more arrangements, the first wall portion 24a may be formed by a bedliner or interior wall of the cargo bed, while the second wall portion 24b may be formed by a metal exterior wall of the truck 20.

The sidewall 24 may have a cavity 24c formed between the first and second wall portions 24a, 24b. An insert 26 may be positioned within the cavity 24c. The insert 26 may define at least one elongated compartment 28 extending along the sidewall cavity 24c in a direction leading from a rear end 20r of the pickup truck toward a front end 20f of the pickup truck 20. As used herein, the term “elongated compartment” refers to a compartment having a length dimension L1 of the compartment greater than a width or diameter D1 of the compartment. The compartment may be a distinct, continuous volume of space in which one or more items may be positioned for storage, transport, and/or other purposes.

In one or more arrangements, depending on the desired length(s) of the elongated compartment(s) 28, the insert 26 may be formed from one or more individually formed insert elements positioned end-to-end within the cavity 24c to form elongated compartment(s) having the desired length(s). Each insert element may include one or more compartment portions or segments which, when placed in coaxial alignment within the sidewall 24, combine to form a single elongated compartment 28. Insert 26 and/or any constituent insert elements may be molded or otherwise fabricated using any suitable methods and materials.

A forward end of an elongated compartment 28 (i.e., an end of the elongated compartment residing closer to the front of the vehicle than to the rear of the vehicle) may have a wall positioned therein, to prevent items or parts of items stored in the compartment from falling out of the forward end of the elongated compartment during motion of the vehicle. In addition, elongated compartments having different lengths and/or diameters may be formed in the inserts and insert elements described herein.

In one or more arrangements, the sidewall cavity 24c may extend an entire distance from a rear end 24r of the sidewall 24 to a cab 20c of the pickup truck. Alternatively, the sidewall cavity 24c may be shorter than the length of the sidewall 24.

As shown in the drawings, the insert 26 may be structured to reside above an associated rear wheel well of the truck when positioned in the sidewall cavity 24c. In one or more arrangements, the insert 26 may extend an entire length of the sidewall cavity 24c. For example, the insert 26 may extend the distance from the rear end 24r of the sidewall to a location within a few inches of the cab 20c. Alternatively, the insert 26 may extend along only a portion of the length of the cavity 24c.

In one or more arrangements, and as shown in FIG. 1A, the insert 26 may define a plurality of elongated compartments 28a, 28b, 28c, etc. extending along the sidewall cavity 24c in a direction leading from the rear end 20r of the pickup truck toward the front end 20f of the pickup truck 20. The insert 26 may be, for example, a molded polymeric piece or assembly with the storage compartments 28a, 28b, 28c formed therein. The insert 26 may be positioned and secured in the sidewall cavity 24c during vehicle assembly. In one or more arrangements, a removable cap 30 may be securable to the insert 26 to close or seal an open end of a storage compartment 28 of the insert 26. Any desired number of compartments 28 may be formed in the insert 26, subject to space constraints and other factors.

Referring again to FIGS. 1A and 1B, the pickup truck cargo bed 22 may also include another sidewall 124 positioned opposite and spaced apart from the sidewall 24, in a known manner. The other sidewall 124 may have another first wall portion 124a facing into the cargo bed 22. The other sidewall 124 may also have another second wall portion 124b residing opposite and spaced apart from the other first wall portion 124a in a direction away from the cargo bed 22. The other sidewall 124 may have another cavity 124c formed between the other first wall portion 124a and the other second wall portion 124b. In one or more arrangements, another insert 126 may be positioned within the other cavity 124c. The other insert 126 may define at least one elongated compartment 128 extending along the other sidewall cavity 124c in a direction leading from a rear end 20r of the pickup truck toward a front end 20f of the pickup truck 20. In one or more arrangements, and as shown in FIG. 1A, the insert 126 may define a plurality of elongated compartments 128a, 128b, 128c, etc. extending along the other sidewall cavity 124c in a direction leading from the rear end 20r of the pickup truck toward the front end 20f of the pickup truck 20.

The insert(s) and compartment(s) in the other sidewall 124 may be structured in the same manner as the insert(s) and compartment(s) in sidewall 24, or the insert(s) and compartment(s) in the other sidewall 124 may be structured differently. For example, compartment(s) in the first sidewall insert 26 described may have different sizes and/or shapes that the compartment(s) formed in the second sidewall insert 126. This may increase a user's flexibility of use.

In one or more arrangements, the compartments 28, 128 may have cylindrical shapes. In other arrangements, compartments may have any of a variety of other shapes, depending on such factors as the shape(s) of items to be stored therein.

As seen in FIGS. 1Aand 1B, an end of the sidewall cavities 24c, 124c may open in a direction toward the rear 20r of the pickup truck 20. This enables items to be inserted into the sidewall cavities elongated compartments 28, 128 from the rear of the truck 20. A tailgate 42 of the truck 20 may be mounted adjacent the sidewalls 24, 124 and may be structured to be movable between an open condition (FIG. 1A) and a closed condition (FIG. 1B), in a known manner. The sidewall cavities 24c, 124c may be structured to be closable at their open ends by moving the tailgate 42 to the closed condition. The sidewall cavities 24c, 124c may also be secured in the closed condition by locking the tailgate 42 in the closed condition. This may aid in securing items positioned in the sidewall elongated compartments 28, 128, by effectively locking the sidewall elongated compartments 28, 128 in closed conditions.

Use of the elongated storage compartments described herein offers the advantages of concealment, securement, and protection of the items positioned in the compartments. Use of such storage compartments also frees cargo bed space for other items.

In other aspects, a vehicle is disclosed herein which includes a sidewall having a first wall portion facing into an interior portion of the vehicle, and a second wall portion residing opposite and spaced apart from the first wall portion and facing in a direction away from the interior of the vehicle. A sidewall may be defined as a wall extending along a side of the vehicle (i.e., a left or right side of the vehicle, from the perspective of a user seated in the vehicle and facing toward a front of the vehicle). The interior portion of the vehicle may be a portion of the vehicle (for example, a cargo bed) located between opposite (i.e., left and right) sidewalls of the vehicle. A cavity is formed between the first and second wall portions. An insert is positioned within the cavity, the insert defining at least one elongated compartment extending along the cavity.

In the above detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope of the invention.

What is claimed is:

1. A pickup truck comprising:
a cargo bed including a sidewall, the sidewall having a first wall portion facing into the cargo bed, a second wall portion residing opposite and spaced apart from the first wall portion and facing in a direction away from the cargo bed, and a cavity formed between the first and second wall portions; and
an insert positioned within the cavity, the insert defining at least one elongated compartment extending along the cavity in a direction leading from a rear end of the pickup truck toward a front end of the pickup truck.

2. The pickup truck of claim 1, further comprising a cap securable to the insert to seal an open end of the at least one elongated compartment.

3. The pickup truck of claim 1, wherein the insert defines multiple elongated compartments extending along the cavity in a direction leading from the rear end of the pickup truck toward the front end of the pickup truck.

4. The pickup truck of claim 1 wherein the at least one elongated compartment is cylindrical.

5. The pickup truck of claim 1, wherein an end of the cavity opens in a direction toward a rear of the pickup truck, wherein the pickup truck further comprises a tailgate mounted adjacent the sidewall and structured to be movable between an open condition and a closed condition, and wherein the cavity is structured to be closable by moving the tailgate to the closed condition.

6. The pickup truck of claim 5, wherein the cavity is structured to be lockable in a closed condition by locking the tailgate in the closed condition using a tailgate lock.

7. The pickup truck of claim 1, further comprising:
another sidewall positioned opposite and spaced apart from the sidewall, the other sidewall having another first wall portion facing into the cargo bed, another second wall portion residing opposite and spaced apart from the other first wall portion in a direction away from the cargo bed, and another cavity formed between the other first wall portion and the other second wall portion; and
another insert positioned within the other cavity, the other insert defining at least one elongated compartment extending along the other cavity in a direction leading from the rear end of the pickup truck toward the front end of the pickup truck.

8. A vehicle comprising:
a sidewall having a first wall portion facing into an interior portion of the vehicle, a second wall portion residing opposite and spaced apart from the first wall portion and facing in a direction away from the interior of the vehicle, and a cavity formed between the first and second wall portions; and
an insert positioned within the cavity, the insert defining at least one elongated compartment extending along the cavity.
